(19) United States
(12) Patent Application Publication
(10) Pub. No.: US 2026/0222473 A1
(43) Pub. Date: Jul. 30, 2026

(54) ATTRITION DETECTION AND PREVENTION

(71) Applicant: Walmart Apollo, LLC, Bentonville, AR (US)

(72) Inventors: Yaotong Cai, Campbell, CA (US); Qianqian Zhang, Castro Valley, CA (US); Wei Shen, Pleasanton, CA (US)

(21) Appl. No.: 19/041,978

(22) Filed: Jan. 30, 2025

(51) Int. Cl. H04L 67/50

(52) U.S. Cl. CPC H04L 67/535

(57) ABSTRACT

Example implementations related to user attrition prediction and interface generation are disclosed. In an example, time series datasets that each include interaction data points including a corresponding time stamp are received. One or more features are extracted and a time series label is generated for each time series dataset based at least in part on a gap between each of the plurality of interaction data points. An attrition prediction model is trained using the time series datasets and the corresponding time series label. The attrition prediction model generates an attrition likelihood. A user-specific time series dataset is received and a user-specific attrition likelihood is generated. An interface intervention is generated based on the user-specific attrition likelihood and instructions are transmitted that cause an interface including the interface intervention to be displayed on a user device associated with the user-specific time series dataset.

### TECHNICAL FIELD

This application relates generally to attrition detection and prevention, and, more particularly, to attrition detection and prevention in network systems.

### BACKGROUND

Some network systems enable users to create accounts and engage with one or more network operations or offerings via an account. Over time, a network system may experience a reduction in user engagement for certain users with some users ceasing interaction with the network system entirely.

### BRIEF DESCRIPTION OF THE DRAWINGS

Various examples will be described below with reference to the following figures.

FIG. 1 depicts an example system for attrition prediction and interface generation, in accordance with some embodiments.

FIGS. 2A and 2B depict interaction time series datasets, in accordance with some embodiments.

FIG. 3 depicts an example training data generation flow, in accordance with some embodiments.

FIG. 4 depicts an example system architecture for interface generation using an attrition likelihood, in accordance with some embodiments.

FIG. 5 depicts a flow diagram illustrating a method of attrition detection and interface generation, in accordance with some embodiments.

FIG. 6 depicts a flow diagram illustrating a method of training data generation, in accordance with some embodiments.

FIG. 7 depicts an example system with a machine-readable medium that includes instructions for attrition detection and interface generation, in accordance with some embodiments.

FIG. 8 depicts an example system with a machine-readable medium that includes instructions for training data generation, in accordance with some embodiments.

FIG. 9 depicts an example computer system that implements one or more of the disclosed processes, in accordance with some embodiments.

### DETAILED DESCRIPTION

Interactions between users and network systems may fluctuate, with the number of users increasing or decreasing over time. For most network systems, user growth (e.g., increase in the number of users) is a desired outcome while user attrition or “churn” (e.g., decrease in the number of users) is undesirable. Although some network systems attempt to minimize churn through targeted interactions, such systems utilize similar strategies across all users, devoting network resources to users who are not at risk of attrition that may be better used on users at higher risk of attrition.

The disclosed systems and methods identify a probability of user attrition for each user (e.g., a probability for churn) and provide targeted interactions or interaction opportunities on the probability. In some embodiments, an attrition prediction model receives one or more time series datasets that each include one or more interaction data points, such as user transaction data, campaign data, and user interaction data for one or more users. The attrition prediction model determines an attrition probability for each time series dataset. Sets of interactions or interaction opportunities may be provided to users based on the attrition probability of a time series dataset associated with the user. For example, users associated with a time series dataset having an attrition probability above a first predetermined threshold may receive a first set of interactions, users associated with a time series dataset having an attrition probability below the first predetermined threshold and above a second predetermined threshold may receive a second set of interactions, and users associated with a time series dataset having an attrition probability below the second predetermined threshold may not receive any interactions or interaction opportunities on the basis of the corresponding attrition probability. Implementation of the attrition prediction model and corresponding targeted interaction sets allows the disclosed systems and methods to reduce resource usage by not spending network resources (e.g., computing cycles, time, bandwidth) on users at a low risk or overly high risk of attrition and may instead utilize less resources in a more effective manner by targeting users that may be retained through targeted intervention.

The disclosed systems and methods provide improved interfaces by providing certain targeted interactions selectively based on an attrition probability for a corresponding user. In some embodiments, targeted interface interventions (e.g., interface elements selected, based, at least in part, on the attrition probability) allow a reduction in resource expenditure while simultaneously providing increased user retention and interaction within a network environment. The reduction in resource expenditure allows the unspent resources to be devoted to additional network tasks or goals.

The attrition prediction model may be generated from a plurality of time series datasets. For example, in some embodiments, one or more features are extracted from each time series dataset in a collection (e.g., a plurality) of time series datasets. A time series label may be created for each dataset. The time series label may be generated, at least in part, based on a gap between each set of interaction data points in a corresponding time series dataset. An attrition prediction model may be trained using the plurality of time series datasets and each of the corresponding time series labels.

In some embodiments, a system including a processor and a non-transitory memory storing instructions is disclosed. The instructions, when executed, cause the processor to receive a plurality of time series datasets that each include a plurality of interaction data points. Each of the plurality of interaction data points includes a corresponding time stamp. One or more features are extracted from each time series dataset in the plurality of time series datasets and a time series label is generated for each time series dataset in the plurality of time series datasets based at least in part on a gap between each of the plurality of interaction data points. An attrition prediction model is trained using the plurality of time series datasets and the time series label for each time series dataset in the plurality of time series datasets. The attrition prediction model generates an attrition likelihood. A user-specific time series dataset is received and a user-specific attrition likelihood is generated for the user-specific time series dataset using the attrition prediction model. An interface intervention is generated based on the user-specific attrition likelihood and instructions are transmitted that cause an interface including the interface intervention to be displayed on a user device associated with the user-specific time series dataset.

In some embodiments, a computer-implemented method is disclosed. The computer-implemented method includes a step of receiving a plurality of time series datasets that each include a plurality of interaction data points. Each of the plurality of interaction data points includes a corresponding time stamp. The computer-implemented method further includes steps of obtaining one or more features for each time series dataset in the plurality of time series datasets, generating a time series label for at least a subset of time series datasets in the plurality of time series datasets based at least in part on a gap between each of the plurality of interaction data points, and training an attrition prediction model using the subset of time series datasets and the time series label for each time series dataset in the subset of time series datasets. The attrition prediction model generates an attrition likelihood. The computer-implemented method further includes steps of receiving a user-specific time series dataset, generating a user-specific attrition likelihood for the user-specific time series dataset using the attrition prediction model, generating an interface intervention based on the user-specific attrition likelihood, and transmitting instructions that cause an interface including the interface intervention to be displayed on a user device associated with the user-specific time series dataset.

In some embodiments, a non-transitory computer-readable medium storing instructions is disclosed. The instructions, when executed by at least one processor, cause a device to perform operations including receiving a plurality of time series datasets that each include a plurality of interaction data points. Each of the plurality of interaction data points includes a corresponding time stamp. The instructions further cause the device to perform operations including extracting one or more features from each time series dataset in the plurality of time series datasets, generating a time series label for each time series dataset in the plurality of time series datasets based at least in part on a gap between each of the plurality of interaction data points, and training an attrition prediction model using the plurality of time series datasets and the time series label for each time series dataset in the plurality of time series datasets. The attrition prediction model generates an attrition likelihood. The instructions further cause the device to perform operations including receiving a user-specific time series dataset, generating a user-specific attrition likelihood for the user-specific time series dataset using the attrition prediction model, generating an interface intervention based on the user-specific attrition likelihood, and transmitting instructions that cause generation of an interface including the interface intervention to a user device associated with the user-specific time series dataset.

This description of the example embodiments is intended to be read in connection with the accompanying drawings that are to be considered part of the entire written description. Terms concerning data connections, coupling and the like, such as “connected” and “interconnected,” and/or “in signal communication with,” refer to a relationship wherein systems or elements are electrically connected (e.g., wired, wireless) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for attrition detection and prevention in network systems. In various embodiments, an attrition prediction model receives a user-specific time series dataset and determines an attrition likelihood (e.g., probability of attrition) of a user associated with the user-specific time series dataset. Based on the attrition likelihood, one or more targeted interface interventions are selected and presented via an interface. The attrition prediction model may include a binary classification framework, an XGBoost framework, a light gradient-boosting machine (LGBM) framework, a long short-term memory (LSTM) framework, a compound framework, and/or any other suitable framework. The targeted interface interventions provide efficient resource usage for targeting a highest impact for user retention within the network system.

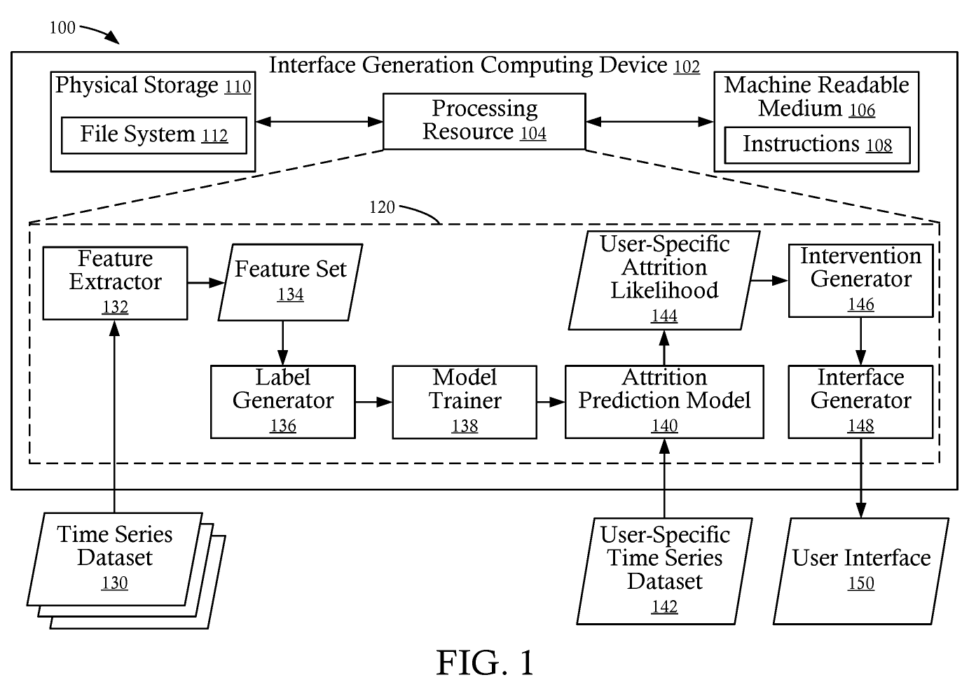

FIG. 1 depicts an example system 100 that provides attrition prediction and interface generation, in accordance with some embodiments. The system 100 includes an interface generation computing device 102 that determines an attrition probability for one or more users and generates an interface responsive to the attrition probability. The interface generation computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The interface generation computing device 102 includes a non-transitory machine-readable medium 106 that may include one or more of a random-access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine-readable medium 106 to perform functions of the interface generation computing device 102, such as determining an attrition probability and generating an interface including at least one interface intervention selected based on the attrition probability. The instructions 108 may include instructions for implementing one or more models. In some embodiments, and as will be described further herein below, the interface generation computing device 102 may execute one or more complex artificial intelligence (AI) systems (e.g., as implemented as machine-readable instructions) to generate an attrition prediction and/or an interface.

The interface generation computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (e.g., installed) in the interface generation computing device 102. In some implementations, physical storage 110 may be accessed as a block storage device.

In some cases, the interface generation computing device 102 may also include a local file system 112 that may be implemented as a layer on top of the physical storage 110. For example, an operating system may be executing on the interface generation computing device 102 (by virtue of the processing resource 104 executing certain instructions 108 related to the operating system) and the operating system may provide a file system 112 to store data on the physical storage 110.

The interface generation computing device 102 may be in communication with one or more additional devices over one or more network channels. For example, in various embodiments, the interface generation computing device 102 may be in communication with a web server, a cloud-based engine including one or more processing devices that may be provisioned for use, a database, a workstation, and/or any other suitable system or device. The interface generation computing device 102 may similarly be in communication, either directly or indirectly, with one or more user computing devices operatively coupled over the network. The other computing systems may be similar to the interface generation computing device 102, and may each include at least a processing resource and a machine-readable medium.

In some embodiments, the interface generation computing device 102 selects one or more interface interventions (e.g., interface elements for inclusion in an interface) based on a user-specific attrition likelihood of a user. The interface generation computing device 102 may implement an attrition prediction and interface generation process 120. In some embodiments, a plurality of time series datasets 130 is received by the attrition prediction and interface generation process 120, for example, by a feature extractor 132.

In some embodiments, each of the time series datasets in the plurality of time series datasets 130 includes a plurality of interaction data points having a time stamp associated therewith. The plurality of time series datasets 130 may be selected from a candidate set of time series datasets. For example, the plurality of time series datasets 130 may be selected from a candidate set of time series datasets using a multi-tiered filtration process that includes at least one filter level based on an interval between interactions in a corresponding time series dataset.

The feature extractor 132 extracts one or more features of the time series datasets as a feature set 134 for use in model generation. The extracted features may include, but are not limited to, network interface interaction features, campaign features such as electronic communication interaction features or push interaction features, application-specific interactions, user features, device features, and/or transactional features.

In some embodiments, interaction features may include interaction data for a network system gathered during a first predetermined time period. For example, the interaction features may be representative of interactions for a predetermined prior time period such as a prior N-hour period (where N is an integer greater than zero) (e.g., 24-hour period), a prior N day (e.g., one-day period), prior N-week period, etc. The interaction data may be representative of user interactions with network resources, interfaces, interface elements, and/or any other suitable interaction data collected by the network system during the first predetermined time period.

In some embodiments, campaign features may include data representative of ongoing interaction campaigns that occur during one or more second predetermined time periods. For example, the campaign features may be representative of interaction campaigns that occurred over one or more time periods such as a prior N-day period (where N is an integer greater than zero) (e.g., one day, three days, five days), an N-week period, etc. Campaign features may be extracted from data representative of one or more types of campaigns. For example, campaign features may be extracted from data representative of an electronic communication (e.g., email) campaign, a push (e.g., notification) campaign, and/or any other suitable campaign.

In some embodiments, transaction features may be extracted from data representative of one or more transactions (e.g., exchange interactions) that occur during a third time period. For example, transaction features may be representative of transactions that occur during a predetermined prior time period such as a prior N-hour period (where N is an integer greater than zero) (e.g., twenty four-hour period), a prior N day (e.g., one-day period), prior N-week period, etc. Transaction data may include, for example, ecommerce transaction data for an ecommerce network system, consolidated transaction data for one or more systems, and/or any other suitable transaction data.

In some embodiments, the extracted feature set 134 is provided to a label generator 136 that generates a label for each time series dataset in the plurality of time series datasets 130 based on one or more extracted features in the feature set 134 and/or additional data. The time series label may identify a gap between a most recent interaction and a second most recent interaction (e.g., an interaction at a most recent time stamp and a second most recent time stamp), a mean of interaction gaps in the corresponding time series dataset, and/or a standard deviation of the interaction gaps. Additionally, or alternatively, in some embodiments, for each time series dataset in the plurality of time series datasets 130, the label generator 136 may apply a label indicating an “active” or “inactive” user associated with the corresponding time series dataset, a label indicating a “retained” or “churned” user, a label indicating one of a “likely to retain,” “potentially churn,” or “likely to churn,” etc. Although example embodiments are discussed herein, it will be appreciated that any suitable label for training of an attrition prediction model (as discussed in greater detail below) may be generated by the label generator 136.

The plurality of time series datasets 130, the feature set 134, and/or the labels generated by the label generator 136 are provided to a model trainer 138 that generates a trained attrition prediction model 140. The model trainer 138 may apply a supervised and/or semi-supervised training framework based on the labels generated by the label generator 136 to train the attrition prediction model 140 to output an attrition likelihood (e.g., probability) of user attrition for a given time series dataset.

In some embodiments, the attrition prediction model 140 includes a binary classification model that classifies a user-specific time series dataset 142 into one of two potential categories, e.g., “active” or “inactive,” “likely to retain” or “potentially churn,” etc. In some embodiments, the attrition prediction model 140 includes a multi-classification model that classifies a user-specific time series dataset 142 into one of three or more potential categories. In some embodiments, the attrition prediction model 140 includes an XGBoost model having hyper-parameters fine-tuned using a Bayesian optimization, an LGBM framework, an LSTM framework, any other suitable framework, or a combination thereof. In some embodiments, the attrition prediction model generates a prediction based, at least in part, on a gap between each of the data points in the time series dataset.

In some embodiments, the attrition prediction model 140 is applied to a user based on a corresponding user-specific time series dataset 142 to generate a user-specific attrition likelihood 144. The user-specific time series dataset 142 may include time series data elements representative of interactions or attempted interactions between a user and a network system and is similar to the plurality of time series datasets 130 used to train the attrition prediction model 140. Although not illustrated in FIG. 1, in some embodiments, the user-specific time series dataset 142 is provided to a feature extractor, such as feature extractor 132, to extract a set of features used by the attrition prediction model 140 to generate a user-specific attrition likelihood 144.

In some embodiments, the user-specific attrition likelihood 144 is used to select user-specific interface interventions for presentation via a user interface. User-specific interface interventions may include, but are not limited to, individual interface elements included in one or more interfaces, an intervention interface generated and provided to a user device (e.g., an electronic communication interface), a push interface, an application interface, or any other suitable interface. In some embodiments, an intervention generator 146 receives the user-specific attrition likelihood 144 and selects one or more interface interventions for inclusion in a user interface.

In some embodiments, the intervention generator 146 may select one or more of an interface type, one or more interface elements, or one or more interface templates. A selected interface type may include a form of interface, such as an electronic communication interface, a web interface, a push interface, an application interface, etc. The interface type may be selected by the intervention generator 146 based on the user-specific attrition likelihood 144. For example, in some embodiments, when user-specific attrition likelihood 144 is above a first predetermined threshold, the intervention generator 146 may select a first interface type (e.g., web-based interface). Additionally, when the user-specific attrition likelihood 144 is below the first predetermined threshold but above a second predetermined threshold, the intervention generator 146 may select a second interface type (e.g., an electronic communication interface). Alternatively, when the user-specific attrition likelihood 144 is below the second predetermined threshold, the intervention generator 146 may select a third interface type (e.g., a push notification) or may select no interface type (e.g., selecting no intervention for the corresponding user).

In some embodiments, the intervention generator 146 may select one or more interface templates for generation of an intervention interface. An interface template may be selected based on the user-specific attrition likelihood 144, a previously selected interface type, and/or additional features or data. For example, the intervention generator 146 may select a first interface template based on a prior selection of a first interface type and/or the user-specific attrition likelihood 144 being above the third predetermined threshold (greater than the first predetermined threshold) and a second interface template based on a prior selection of the first interface type and/or the user-specific attrition likelihood 144 being above the first predetermined threshold but less than the third predetermined threshold. Although embodiments are discussed herein including selection of an interface type and subsequent selection of an interface template, it will be appreciated that each of these steps may be combined into a single process that selects an interface type and interface template simultaneously and/or sequentially.

In some embodiments, the intervention generator 146 may select one or more interface elements for populating a generated interface. The one or more interface elements selected by the intervention generator 146 may include content (e.g., text, images) that correspond to the user-specific attrition likelihood 144, a selected interface type, a selected interface template, and/or other user-specific features or data. For example, the intervention generator 146 may select a first type of content element (e.g., item element, carousel element) based on a selected template interface allowing or requiring the first type of content element and/or a user-specific attrition likelihood 144. The intervention generator 146 may populate the selected content element with user-specific content (e.g., selecting a user-specific item or set of items for inclusion in the item element or carousel element) based on user-specific data and/or features. The user-specific elements may be selected using any suitable selection process.

In some embodiments, the interface type, interface template, interface elements, and/or any other interface components selected by the intervention generator 146 are provided to an interface generator 148 for generation of a user interface 150. The user interface 150 may include the interface template selected by the intervention generator 146 populated by one or more interface elements selected by the intervention generator 146 and/or additional interface elements selected by the interface generator 148. Although embodiments are illustrated as having an intervention generator 146 and an interface generator 148, it will be appreciated that a single generator may select one or more interventions and generate a user interface 150 corresponding to the selected intervention(s).

In some embodiments, the attrition prediction and interface generation process 120 is applied to identify users of a network system having an attrition risk above one or more predetermined thresholds and generating interface interventions to mitigate or reduce the attrition risk. For example, in some embodiments, a user-specific time series dataset 142 including interaction data between the user and the network system may be received by the attrition prediction model 140, which generates a user-specific attrition likelihood 144 for the corresponding user based, at least in part, on the gap between interactions in the user-specific time series dataset 142. When the user-specific attrition likelihood 144 is above a first predetermined threshold, the corresponding user may be likely to withdraw from interaction with the network system (e.g., at a high risk of attrition). Similarly, when the user-specific attrition likelihood 144 is below the first predetermined threshold but above a second predetermined threshold, the corresponding user may potentially withdraw from interaction with the network system. Alternatively, when the user-specific attrition likelihood 144 is below the second predetermined threshold, the corresponding user may be unlikely to withdraw from interaction with the network system (e.g., at a low risk of attrition).

In some embodiments, user-specific interfaces are generated for users associated with user-specific time series datasets 142 having user-specific attrition probabilities within one or more predetermined ranges (e.g., users classified into one or more categories such as “high risk of attrition” or “potential attrition”). A user-specific interface may include a template and/or interface elements selected based on the user classification and/or user-specific data. In some embodiments, users having a user-specific attrition likelihood 144 above a first predetermined threshold may receive a first interface, e.g., a first electronic communication, including a set of first interface elements. Similarly, users having a user-specific attrition likelihood 144 below the first predetermined threshold but above a second predetermined threshold may receive a second interface, e.g., a second electronic communication, including a set of second interface elements. Although example embodiments are discussed herein, it will be appreciated that any number of thresholds and/or any additional data elements may be utilized to generate user-specific interfaces.

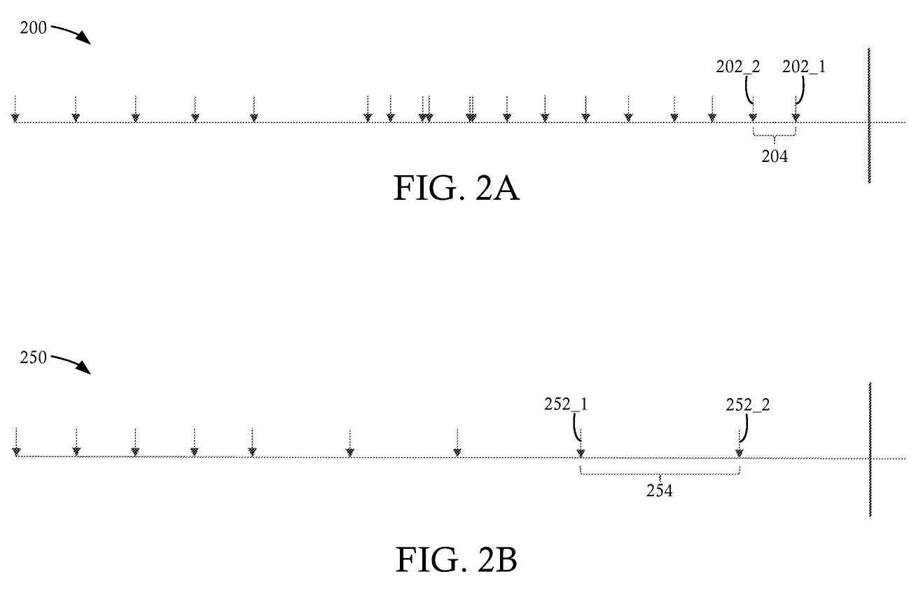

FIGS. 2A and 2B depict interaction time series datasets 200, 250, in accordance with some embodiments. FIG. 2A includes a first time series dataset 200 including a plurality of data points 202_1, 202_2 (collectively “data points 202”) representative of interactions or attempted interactions between a first user and a network system and FIG. 2B includes a second time series dataset 250 including a plurality of data points 252_1, 252_2 (collectively “data points 252”) representative of interactions or attempted interactions between a second user and a network system. As illustrated in FIGS. 2A and 2B, the first time series dataset 200 includes a first gap 204 between a most recent data point 202_1 and a second most recent data point 202_2 and the second time series dataset 250 includes a second gap 254 between a most recent data point 252_1 and a second most recent data point 252_2. As discussed above, a label applied to the first time series dataset 200, for example, by the label generator 136 discussed above with respect to FIG. 1, may include an indication of a gap between the most recent data points 202_1, 252_1 and the second most recent data points 202_2, 252_2.

In some embodiments, a gap between one or more data points 202, 252, such as the gap 204, 254 between a most recent data point 202_1, 252_1 and a second most recent data point 202_2, 252_2, may be partially indicative of an attrition likelihood for a corresponding user. For example, in the illustrated examples, the first time series dataset 200 includes a smaller gap 204 between a most recent data point 202_1 and a second most recent data point 202_2 as compared to the gap 254 between a most recent data point 252_1 and a second most recent data point 252_2 of the second time series dataset 250. The smaller gap 204 of the first time series dataset 200 may be indicative of a low likelihood of user attrition for the first user and the larger gap 254 of the second time series dataset 250 may be indicative of a higher likelihood of user attrition for the second user.

Similarly, in some embodiments, a larger gap 254 may not be indicative of a higher probability of attrition, or, conversely, a smaller gap 204 may be indicative of a higher probability of attrition, based on a mean and/or a standard deviation of the gaps between data points 202, 252 for the corresponding time series dataset 200, 250. For example, a user may have a mean interaction time based on interaction data points in a corresponding time series dataset 200, 250. As the time from a most recent interaction increasingly exceeds the mean interaction time (or the mean interaction time plus one or more standard deviations), the likelihood of user attrition may similarly increase for the corresponding user.

As discussed above with respect to FIG. 1, in some embodiments, an attrition prediction model, such as attrition prediction model 140, may utilize one or more features of a time series dataset 200, 250, such as a gap 204 between a most recent data point 202_1, 252_1 and a second most recent data point 202_2, 252_2, a mean of gaps between data points 202, 252, or a standard deviation of gaps between data points 202, 252 to predict a user-specific attrition likelihood.

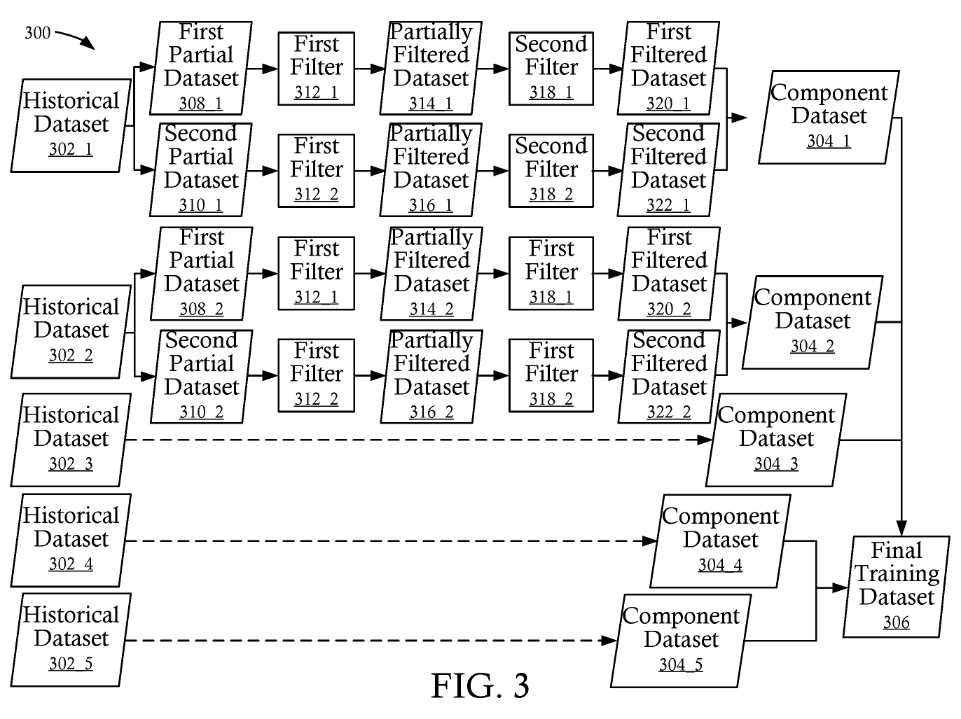

FIG. 3 depicts an example training data generation flow 300, in accordance with some embodiments. The training data generation flow 300 may be implemented by any suitable system or device, such as the interface generation computing device 102 discussed above with respect to FIG. 1. In some embodiments, the training data generation flow 300 may be implemented to select a plurality of time series datasets, such as the plurality of time series datasets 130, used for training of a corresponding attrition prediction model, such as attrition prediction model 140.

As illustrated in FIG. 3, historical datasets 302_1 to 302_5 (collectively “historical datasets 302”) may be received for one or more time periods. Each of the historical datasets 302_1 to 302_5 may include historical interaction data, historical campaign data, historical transaction data, or any other suitable historical data. In some embodiments, each of the historical datasets 302_1 to 302_5 include time series data (e.g., time series datasets and/or time series data points) beginning from a predetermined time. For example, a first historical dataset 302_1 may include time series data with initial data points beginning at a first time, a second historical dataset 302_2 may include time series data with initial data points beginning at a second time, a third historical dataset 302_3 may include time series data with initial data points beginning at a third time, a fourth historical dataset 302_4 may include time series data with initial data points beginning at a fourth time, and a fifth historical dataset 302_5 may include time series data with initial data points beginning at a fifth time.

In some embodiments, each subsequent time period represents a prior time period (e.g., the second time period is earlier in time than the first time period, the third time period is earlier in time than the second time period, the fourth time period is earlier in time than the third time period, and the fifth time period is earlier in time than the fourth time period). Although example embodiments are discussed herein, it will be appreciated that the time period of any of the historical datasets 302 may include any suitable initial time and/or any suitable end time. The time periods of each of the historical datasets 302 may be overlapping, partially overlapping, and/or non-overlapping and may further include continuous, serial, or discontinuous time periods.

In some embodiments, each of the historical datasets 302 is divided and filtered to generate a corresponding component dataset 304_1 to 304_5 (collectively “component datasets 304”) for inclusion in a final training dataset 306. For example, each of the historical datasets 302 may be split into a first partial dataset 308_1, 308_2 (collectively “first partial datasets 308”) and a second partial dataset 310_1, 310_2 (collectively “second partial datasets 310”). Although not expressly illustrated, it will be appreciated that similar processes are performed for each of the historical datasets 302 as discussed herein with respect to a first historical dataset 302_1.

The historical datasets 302 may be split according to one or more predetermined criteria. For example, in some embodiments, the first partial datasets 308 may include interaction data points having a time stamp corresponding to a first time period of the respective one of the historical datasets 302 and the second partial datasets 310 may include interaction data points having a time stamp corresponding to a second time period of the respective one of the historical datasets 302.

In some embodiments, each of the partial datasets 308, 310 may be filtered by a first filter 312_1, 312_2 to generate corresponding partially filtered datasets 314_1, 314_2, 316_1, 316_2 (collectively “first partially filtered datasets 314” and “second partially filtered datasets 316,” respectively). In some embodiments, a first filter 312_1, 312_2 may remove time series datasets (or time series data points) that fail to meet one or more parameters. For example, in some embodiments, each of the partial datasets 308, 310 may be filtered to retain only time series datasets that include at least two interaction data points prior to a most recent interaction data point over a predetermined time period (e.g., at least M interactions over the last N years beginning from the date of the most recent interaction point, where M and N are each integers greater than zero).

In some embodiments, each of the partially filtered datasets 314, 316 may be further filtered by a second filter 318_1, 318_2 to generate corresponding filtered datasets 320_1, 320_2, 322_1, 322_2 (collectively “first filtered datasets 320” and “second filtered datasets 322,” respectively). In some embodiments, a second filter 318_1, 318_2 may remove time series datasets (or time series data points) that fail to meet one or more parameters. For example, in some embodiments, each of the partially filtered datasets 314, 316 may be filtered to remove time series datasets that have a gap between a first order after the initial time period and a last order of the time series dataset greater than a predetermined time period, where the last interaction data was before a predetermined time period, and/or where the interval between a prior interaction and the most recent interaction is greater than a predetermined time period. Although example embodiments are discussed herein, it will be appreciated that the historical datasets 302 may be filtered using any suitable criteria to generate corresponding filtered datasets 320, 322.

In some embodiments, each of the filtered datasets 320, 322 for a corresponding one of the historical datasets 302 (e.g., a first historical dataset 302_1 for filtered datasets 320_1 and 322_1) may be combined into a corresponding one of the component datasets 304. Subsequently, each of the component datasets 304 may be combined into the final training dataset 306. The final training dataset 306 includes portions of each of the historical datasets 302 that match each of the filter conditions for each of the first filters 312_1, 312_2 and the second filters 318_1, 318_2. By dividing the historical datasets 302 into multiple sets (or slices), the training data generation flow 300 enables parallel processing of historical datasets 302, decreasing the necessary time for generating the final training dataset 306. The final training dataset 306 may be provided for training of a corresponding attrition prediction model, for example, being provided as the plurality of time series datasets 130 for training of the attrition prediction model 140 discussed above with respect to FIG. 1.

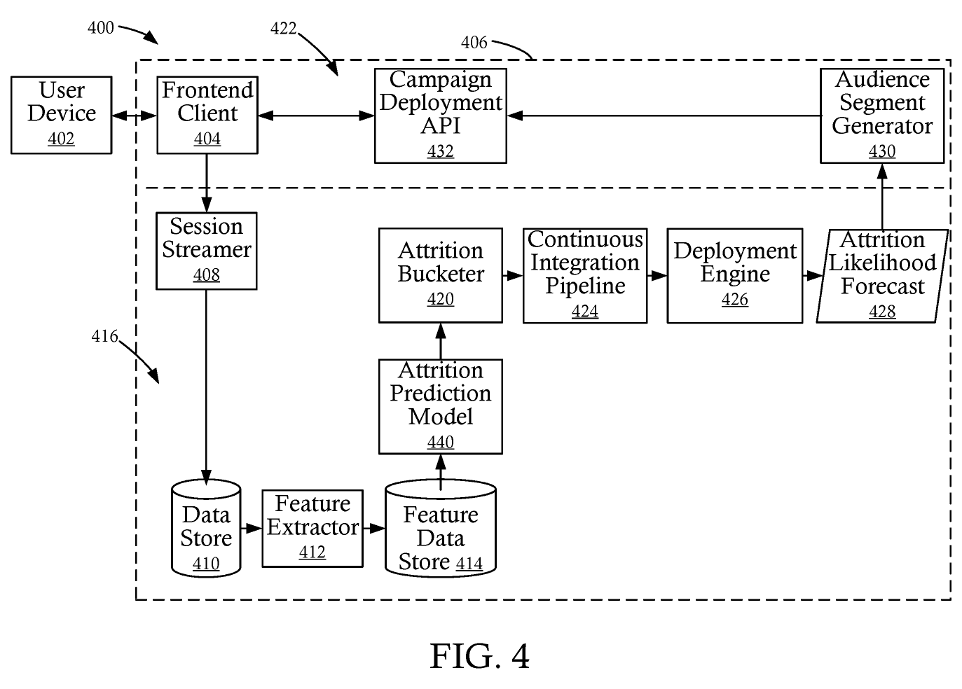

FIG. 4 depicts an example system architecture 400 for interface generation using an attrition likelihood, in accordance with some embodiments. The system architecture 400 may be implemented by any suitable system or device, such as, for example, the interface generation computing device 102 discussed above with respect to FIG. 1. The system architecture 400 may be implemented as part of the attrition prediction and interface generation process 120 executed by the interface generation computing device 102.

In some embodiments, a user device 402 interacts with a frontend client 404 to perform one or more interactions with a network system, such as the network system 406 including the frontend client 404. Each interaction between the user device 402 and the frontend client 404 is provided to a session streamer 408 that stores interaction data representative of the interactions in a data store 410. A feature extractor 412 obtains stored interaction data from the data store 410 and generates a set of features for use in model training, as discussed above with respect to FIG. 1. The set of features is stored in a feature data store 414.

In some embodiments, the set of features is obtained from the feature data store 414 and is utilized to train an attrition prediction model 440 within a training environment 416. A training process including a model validation check may be applied to generate the attrition prediction model 440. The attrition prediction model may include a binary classification model and/or a multi-classification model. In some embodiments, the output of the attrition prediction model 440 includes an attrition likelihood that is used by an attrition bucketer 420 to generate two or more groups (e.g., buckets) of users based on the corresponding attrition likelihood.

In some embodiments, the attrition prediction model 440 is deployed to a deployment environment 422 that includes a continuous integration pipeline 424 and a deployment engine 426 for deploying newly trained attrition prediction models, such as attrition prediction model 440. The attrition prediction model 440 generates an attrition likelihood forecast 428 for a user associated with the user device 402 and outputs the attrition likelihood forecast 428 to an audience segment generator 430. The audience segment generator 430 may add the user and/or user device 402 to a selected segment and generate one or more intervention interfaces via a campaign deployment application programming interface (API) 432. In some embodiments, the campaign deployment API collects interaction data for each generated intervention interface and provides the interaction data to the frontend client 404 for use in subsequent training or re-training of an attrition prediction model 440.

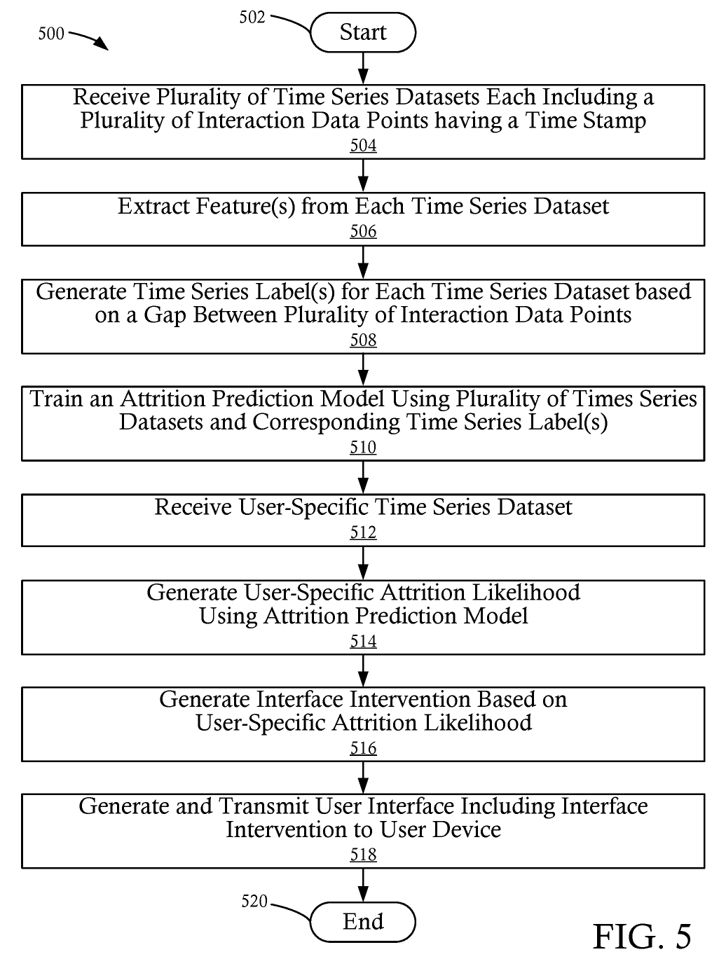

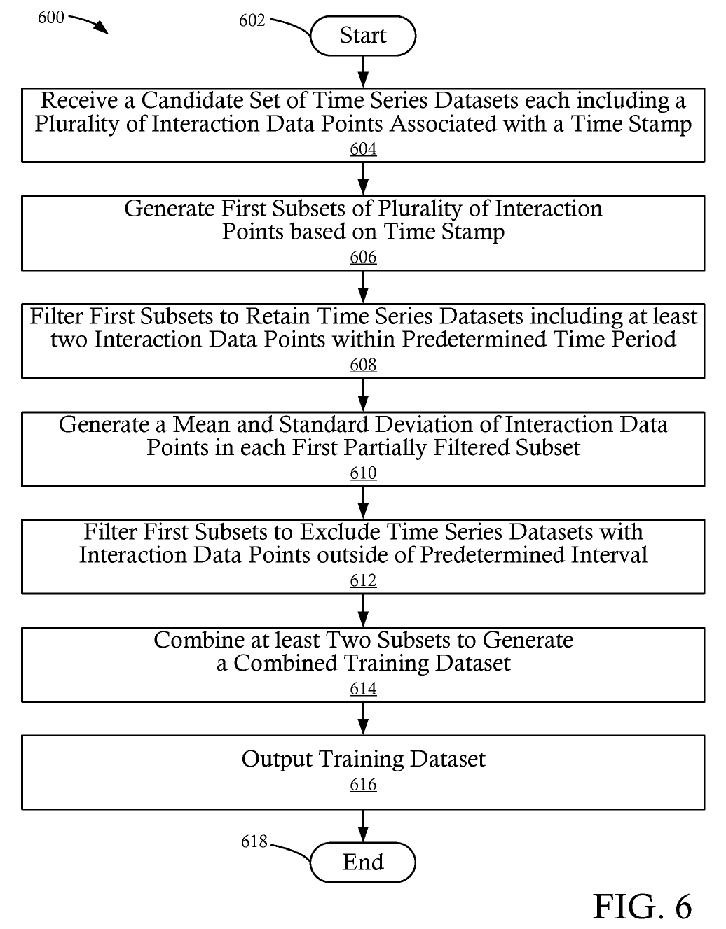

FIGS. 5 and 6 are flow diagrams depicting various example methods. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the methods may be combined.

The methods shown in FIGS. 5 and 6 may be implemented in the form of executable instructions stored on a machine-readable medium and executed by a processing resource and/or in the form of electronic circuitry. For example, aspects of the methods may be described below as being performed by an attrition prediction and interface generation process, an example of which may be the attrition prediction and interface generation process 120 running on a hardware processing resource 104 of the interface generation computing device 102 described above. Additionally, other aspects of the methods described below may be described with reference to other elements shown in FIG. 1 for non-limiting illustration purposes.

FIG. 5 depicts a flow diagram illustrating a method 500 of attrition detection and interface generation, in accordance with some embodiments. Method 500 starts at block 502 and continues to block 504, where a plurality of time series datasets are received. Each of the time series datasets in the plurality of time series datasets includes a plurality of interaction data points having a time stamp associated therewith.

At block 506, one or more features are extracted from each time series dataset in the plurality of time series datasets. The extracted features may include, but are not limited to, network interface interaction features, campaign features such as electronic communication interaction features or push interaction features, application-specific interactions, user features, device features, and/or transactional features. In some embodiments, the one or more features are extracted by a feature extractor, such as the feature extractor 132 discussed above with respect to FIG. 1.

At block 508, a label, e.g., a time series label, is generated for each time series dataset in the plurality of time series datasets. Each label may be generated based, at least in part, on a gap between a plurality of interaction data points within a corresponding one of the plurality of time series datasets. In various embodiments, one or more of a gap between a most recent interaction data point and a second most recent interaction data point, a mean gap between each of the interaction data points, and/or a standard deviation of the gap between each of the interaction data points may be used to generate a time series label.

At block 510, an attrition prediction model is trained using the plurality of time series datasets, the extracted features, and the corresponding time series labels. The attrition prediction model may include a binary classification framework, an XGBoost framework, an LGBM framework, an LSTM framework, a compound framework, and/or any other suitable framework. The attrition prediction model may be generated using an iterative training process that applies a model validation process during each iterative cycle.

At block 512, a user-specific time series dataset is received. The user-specific time series dataset may be similar to the time series datasets received at block 504. At block 514, a user-specific attrition likelihood is generated by the attrition prediction model based on the user-specific time series dataset. The user-specific attrition likelihood may include a probability value, a categorical grouping, and/or any other suitable output. In some embodiments, a user-specific attrition likelihood includes a grouping into one of two or more potential classifications, such as “likely attrition,” “possible attrition,” and “unlikely attrition.”

At block 514, one or more interface interventions (e.g., interfaces, interface components) are generated based on the user-specific attrition likelihood. A user-specific interface may include a template and/or interface elements selected based on a user classification and/or user-specific data. For example, in some embodiments, users having a user-specific attrition likelihood above a first predetermined threshold may receive a first interface, e.g., a first electronic communication, including a set of first interface elements, and users having a user-specific attrition likelihood below the first predetermined threshold but above a second predetermined threshold may receive a second interface, e.g., a second electronic communication, including a set of second interface elements. Although example embodiments are discussed herein, it will be appreciated that any suitable intervention interface may be provided based on the user-specific attrition likelihood.

At block 518, instructions to cause display of a user interface including the intervention interface on a user device are generated and transmitted to the corresponding user device. The user device may be associated with the same user associated with the user-specific time series dataset. In some embodiments, the intervention interface includes an electronic communication transmitted to a user device via one or more electronic communication protocols. At block 520, the method 500 ends.

FIG. 6 depicts a flow diagram illustrating a method 600 of training data generation, in accordance with some embodiments. Method 600 starts at block 602 and proceeds to block 604, where a candidate set of time series datasets is received. Each of the time series datasets in the candidate set includes a plurality of interaction data points having a time stamp associated therewith.

At block 606, a plurality of first subsets of interaction data points are generated based on corresponding time stamps for the interaction data points. For example, in some embodiments, the plurality of first subsets may be generated by splitting the candidate set of time series datasets into one or more first partial datasets and one or more second partial datasets. The candidate datasets may be split according to one or more predetermined criteria. For example, in some embodiments, the first partial datasets may include interaction data points having a time stamp corresponding to a first time period of one or more candidate datasets and the second partial datasets may include interaction data points having a time stamp corresponding to a second time period of one or more candidate datasets.

At block 608, each of the first subsets is filtered to generate first partially filtered subsets. For example, in some embodiments, each of the first subsets is filtered to retain only time series datasets including at least two interaction data points that are within a predetermined time period (e.g., at least M interactions over the last N years beginning from the date of the most recent interaction pint, where M and N are each integers greater than zero).

At block 610, a mean and a standard deviation are generated for the interaction data points in each time series dataset in each of the first partially filtered subsets and, at block 612, each of the first partially filtered subsets is further filtered to generate filtered subsets. For example, in some embodiments, the first partially filtered subsets are filtered to exclude time series datasets with interaction data points outside of a predetermined interval. Although embodiments are discussed herein including both a first filtering process at block 608 and a second filtering process at block 612, it will be appreciated that either of the filtering processes may be omitted. Similarly, it will be appreciated that the filter processes may be combined and/or additional or alternative filtering processes may be used.

At block 614, at least two of the filtered subsets are combined to generate a combined training dataset, e.g., a plurality of time series datasets appropriate for training of an attrition prediction model. At block 616, the combined training dataset is output and, at block 618, the method 600 ends.

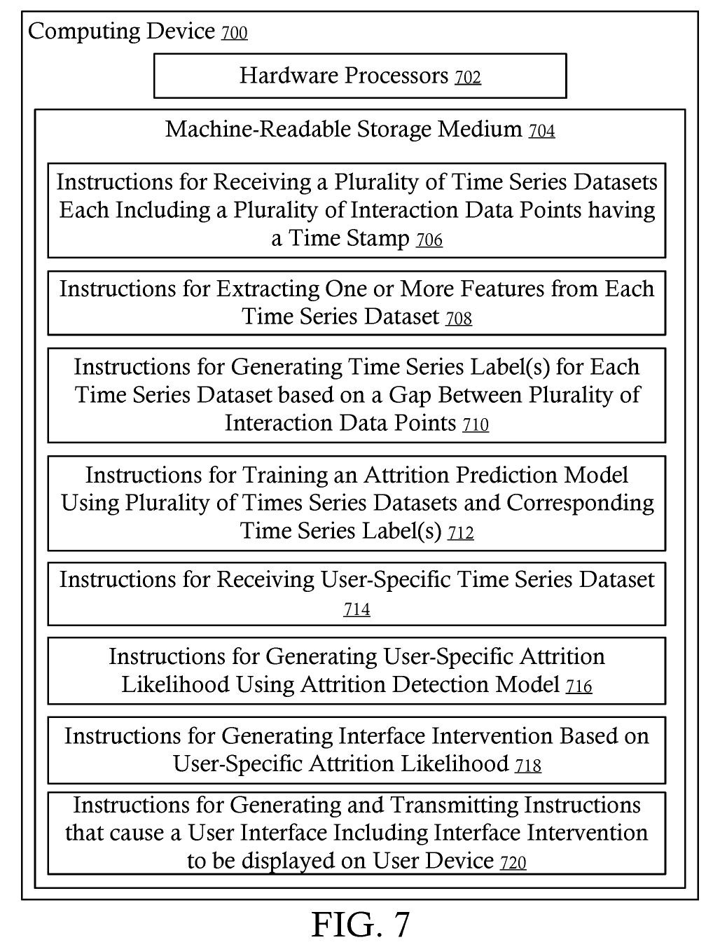

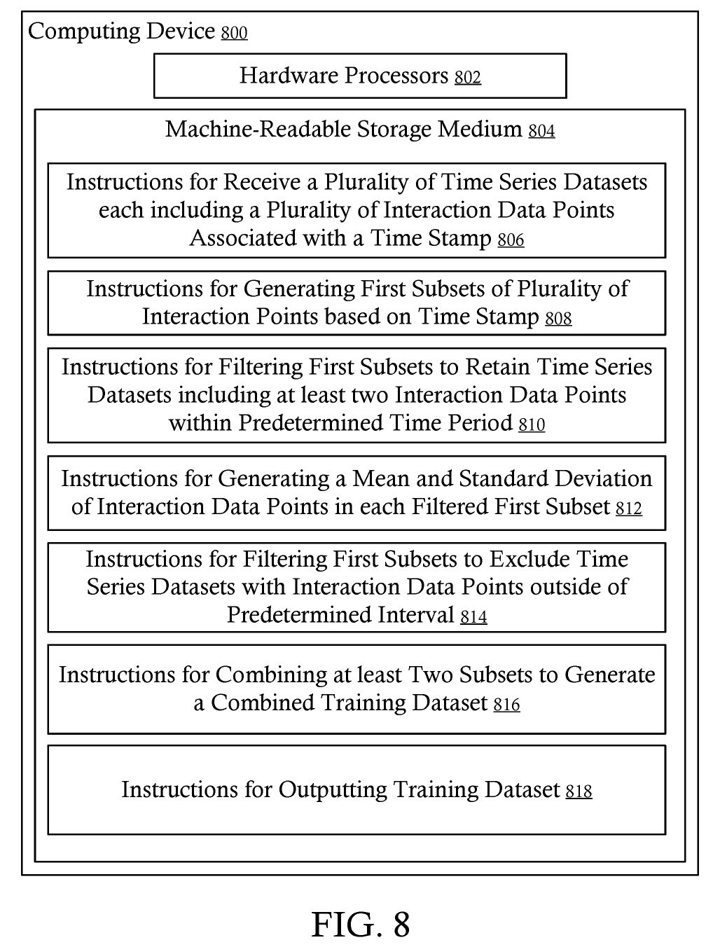

FIGS. 7 and 8 depict example systems 700, 800, respectively, that include non-transitory, machine-readable medium 704, 804, respectively, encoded with example instructions executable by processing resources 702, 802, respectively. In some implementations, the systems 700, 800 may be useful for implementing aspects of the interface generation process 120 of FIG. 1 or the systems 300, 400 of FIGS. 3 and 4, or for performing aspects of methods 500, 600 of FIGS. 5 and 6, respectively. For example, the instructions encoded on machine-readable medium 704, 804 may be included in instructions 108 of FIG. 1. In some implementations, functionality described with respect to FIG. 1 may be included in the instructions encoded on machine-readable medium 704, 804.

The processing resources 702, 802 may include a microcontroller, a microprocessor, central processing unit core(s), an ASIC, an FPGA, and/or other hardware devices suitable for retrieval and/or execution of instructions from the machine-readable medium 704, 804 to perform functions related to various examples. Additionally, or alternatively, the processing resources 702, 802 may include or be coupled to electronic circuitry or dedicated logic for performing some or all of the functionality of the instructions described herein.

The machine-readable medium 704, 804 may be any medium suitable for storing executable instructions, such as RAM, ROM, EEPROM, flash memory, a hard disk drive, an optical disc, or the like. In some example implementations, the machine-readable medium 704, 804 may be a tangible, non-transitory medium. The machine-readable medium 704, 804 may be disposed within the systems 700, 800, respectively, in which case the executable instructions may be deemed installed or embedded on the system. Alternatively, the machine-readable medium 704, 804 may be a portable (e.g., external) storage medium and may be part of an installation package.

As described further herein, the machine-readable medium 704, 804 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIGS. 7 and 8.

With reference to FIG. 7, the machine-readable medium 704 includes instructions 706 to 720. Instructions 706, when executed, cause the processing resource 702 to receive a plurality of time series datasets each including a plurality of interaction data points having a time stamp associated therewith. Instructions 708, when executed, cause the processing resource 702 to extract one or more features from each of the time series datasets.

Instructions 710, when executed, cause the processing resource 702 to generate one or more time series labels for each time series dataset in the plurality of time series datasets based, at least in part, on a gap between a plurality of interaction points in the corresponding time series dataset. In various embodiments, one or more of a gap between a most recent interaction data point and a second most recent interaction data point, a mean gap between each of the interaction data points, and/or a standard deviation of the gap between each of the interaction data points may be used to generate a time series label.

Instructions 712, when executed, cause the processing resource 702 to train an attrition prediction model using the plurality of time series datasets, the extracted features, and/or the one or more labels generated for each time series dataset. The attrition prediction model may include a binary classification framework, an XGBoost framework, an LGBM framework, an LSTM framework, a compound framework, and/or any other suitable framework. The attrition prediction model may be generated using an iterative training process that applies a model validation process during each iterative cycle.

Instructions 714, when executed, cause the processing resource 702 to receive a user-specific time series dataset. Instructions 716, when executed, cause the processing resource 702 to generate a user-specific attrition likelihood by using the attrition prediction model. The user-specific time series model may be provided to the attrition prediction model, which generates a user-specific attrition prediction output (e.g., a user-specific attrition likelihood value, a user-specific attrition likelihood classification).

Instructions 718, when executed, cause the processing resource 702 to generate one or more interface interventions based on the user-specific attrition likelihood. A user-specific interface may include a template and/or interface elements selected based on a user classification and/or user-specific data. For example, in some embodiments, users having a user-specific attrition likelihood above a first predetermined threshold may receive a first interface, e.g., a first electronic communication, including a set of first interface elements and users having a user-specific attrition likelihood below the first predetermined threshold but above a second predetermined threshold may receive a second interface, e.g., a second electronic communication, including a set of second interface elements. Although example embodiments are discussed herein, it will be appreciated that any suitable intervention interface may be provided based on the user-specific attrition likelihood.

Instructions 720, when executed, cause the processing resource 702 to generate and transmit instructions that cause a user interface, such as an intervention interface including the one or more selected interface interventions, on a user device. The user device may be associated with the same user associated with the user-specific time series dataset. In some embodiments, the intervention interface includes an electronic communication transmitted to a user device via one or more electronic communication protocols.

With reference to FIG. 8, the machine-readable medium 804 includes instructions 806 to 818. Instructions 806, when executed, cause the processing resource 802 to receive a plurality of time series datasets. Each of the time series datasets includes a plurality of interaction data points each associated with a time stamp.

Instructions 808, when executed, cause the processing resource 802 to generate a one or more first subsets of interaction data points based on corresponding time stamps for the interaction data points. For example, in some embodiments, first subsets may be generated by splitting the plurality of time series datasets into one or more first partial datasets and one or more second partial datasets. The plurality of time series datasets may be split according to one or more predetermined criteria. For example, in some embodiments, the first partial datasets may include interaction data points having a time stamp corresponding to a first time period of one or more of the plurality of time series datasets and the second partial datasets may include interaction data points having a time stamp corresponding to a second time period of one or more of the plurality of time series datasets.

Instructions 810, when executed, cause the processing resource 802 to filter each of the first subsets to generate first partially filtered subsets. For example, in some embodiments, each of the first subsets is filtered to retain only time series datasets including at least two interaction data points that are within a predetermined time period (e.g., at least M interactions over the last N years beginning from the date of the most recent interaction point, where M and N are each integers greater than zero).

Instructions 812, when executed, cause the processing resource 802 to generate a mean and a standard deviation for the interaction data points in each time series dataset in each of the first partially filtered subsets. Instructions 814, when executed, cause the processing resource 802 to further filter each of the first partially filtered subsets to generate filtered subsets. For example, in some embodiments, the first partially filtered subsets are filtered to exclude time series datasets with interaction data points outside of a predetermined interval. Although embodiments are discussed herein including both a first filtering process and a second filtering process, it will be appreciated that either of the filtering processes may be omitted. Similarly, it will be appreciated that the filter processes may be combined and/or additional or alternative filtering processes may be used.

Instructions 816, when executed, cause the processing resource 802 to combine at least two of the filtered subsets to generate a combined training dataset, e.g., a plurality of time series datasets appropriate for training of an attrition prediction model. Instructions 818, when executed, cause the processing resource 802 to output the combined training dataset.

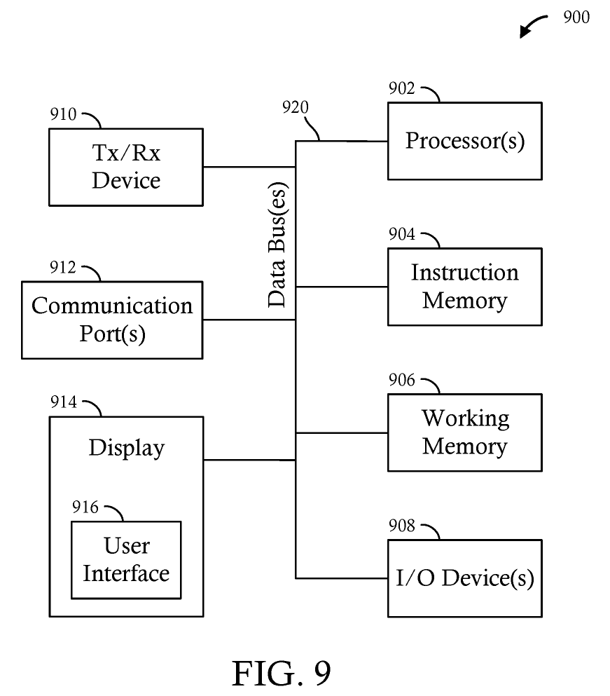

FIG. 9 illustrates a block diagram of a computing device 900, in accordance with some embodiments. Although FIG. 9 is described with respect to certain components shown therein, it will be appreciated that the elements of the computing device 900 may be combined, omitted, and/or replicated. In addition, it will be appreciated that additional elements other than those illustrated in FIG. 9 may be added to the computing device.

As shown in FIG. 9, the computing device 900 may include one or more processing resources 902, instruction memory 904, working memory 906, input/output devices 908, transceiver 910, communication ports 912, display 914, and/or any other suitable elements each operatively coupled to one or more data buses 920. The data buses 920 allow for communication among the various components. The data buses 920 may include wired, or wireless, communication channels.

The one or more processing resources 902 may include any processing circuitry operable to control operations of the computing device 900. In some embodiments, the one or more processing resources 902 include one or more distinct processors, each having one or more cores (e.g., processing circuits). Each of the distinct processors may have the same or different structure. The one or more processing resources 902 may include one or more central processing units (CPUs), one or more graphics processing units (GPUs), application-specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 902 may also be implemented by a controller, a microcontroller, an application-specific integrated circuit (ASIC), a field programmable gate array (FPGA), a programmable logic device (PLD), etc.

In some embodiments, the one or more processing resources 902 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, and user interaction applications.

The instruction memory 904 may store instructions that are accessed (e.g., read) and executed by at least one of the one or more processing resources 902. For example, the instruction memory 904 may be a non-transitory, computer-readable storage medium such as a read-only memory (ROM), an electrically erasable programmable read-only memory (EEPROM), flash memory (e.g., NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, a CD-ROM, any non-volatile memory, or any other suitable memory. The one or more processing resources 902 may perform a certain function or operation by executing code, stored on the instruction memory 904, embodying the function or operation. For example, the one or more processing resources 902 may execute code stored in the instruction memory 904 to perform one or more of any function, method, or operation disclosed herein.

Additionally, the one or more processing resources 902 may store data to, and read data from, the working memory 906. For example, the one or more processing resources 902 may store a working set of instructions to the working memory 906, such as instructions loaded from the instruction memory 904. The one or more processing resources 902 may also use the working memory 906 to store dynamic data created during one or more operations. The working memory 906 may include, for example, random-access memory (RAM) such as a static random-access memory (SRAM) or dynamic random-access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, a CD-ROM, any non-volatile memory, or any other suitable memory. Although embodiments are illustrated herein including separate instruction memory 904 and working memory 906, it will be appreciated that the computing device 900 may include a single memory unit that operates as both instruction memory and working memory. Further, although embodiments are discussed herein including non-volatile memory, it will be appreciated that the computing device 900 may include volatile memory components in addition to at least one non-volatile memory component.

In some embodiments, the instruction memory 904 and/or the working memory 906 includes an instruction set, in the form of a file for executing various methods, such as methods for predicting a user attrition likelihood and generating one or more intervention interfaces based on the attrition likelihood, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments, a compiler or interpreter converts the instruction set into machine executable code for execution by the one or more processing resources 902.

The input/output devices 908 may include any suitable device that allows for data input or output. For example, the input/output devices 908 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 910 and/or the communication port(s) 912 allow for communication with a network. For example, if a communication network is a cellular network, the transceiver 910 allows communications with the cellular network. In some embodiments, the transceiver 910 is selected based on the type of the communication network the computing device 900 will be operating in. The one or more processing resources 902 are operable to receive data from, or send data to, a network, via the transceiver 910.

The communication port(s) 912 may include any suitable hardware, software, and/or combination of hardware and software that is capable of coupling the computing device 900 to one or more networks and/or additional devices. The communication port(s) 912 may be arranged to operate with any suitable technique for controlling information signals using a desired set of communications protocols, services, or operating procedures. The communication port(s) 912 may include the appropriate physical connectors to connect with a corresponding communications medium, whether wired or wireless, for example a serial port such as a universal asynchronous receiver/transmitter (UART) connection, a Universal Serial Bus (USB) connection, or any other suitable communication port or connection. In some embodiments, the communication port(s) 912 allows for the programming of executable instructions in the instruction memory 904. In some embodiments, the communication port(s) 912 allow for the transfer (e.g., uploading or downloading) of data, such as machine-learning model training data.

In some embodiments, the communication port(s) 912 couples the computing device 900 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 910 and/or the communication port(s) 912 utilize one or more communication protocols. Examples of wired protocols may include, but are not limited to, Universal Serial Bus (USB) communication, RS-232, RS-422, RS-423, and RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 914 may be any suitable display, and may display the user interface 916. The user interface 916 may enable user interaction with intervention interfaces. For example, the user interface 916 may be a user interface for an application of a network environment operator that allows a user to view and interact with the operator’s website and/or an electronic communication. In some embodiments, a user may interact with the user interface 916 by engaging the input/output devices 908. In some embodiments, the display 914 may be a touchscreen, where the user interface 916 is displayed on the touchscreen.

The display 914 may include a screen such as, for example, a Liquid Crystal Display (LCD) screen, a light-emitting diode (LED) screen, an organic LED (OLED) screen, a movable display, a projection, etc. In some embodiments, the display 914 may include a coder/decoder, also known as Codecs, to convert digital media data into analog signals. For example, the visual peripheral output device may include video Codecs, audio Codecs, or any other suitable type of Codec.

In some embodiments, the computing device 900 implements one or more modules or engines, each of which is constructed, programmed, configured, or otherwise adapted to autonomously carry out a function or set of functions. A module/engine may include a component or arrangement of components implemented using hardware, such as by an application-specific integrated circuit (ASIC) or field-programmable gate array (FPGA), for example, or as a combination of hardware and software, such as by a microprocessor system and a set of program instructions that adapt the module/engine to implement the particular functionality that (while being executed) transforms the microprocessor system into a special-purpose device. A module/engine may also be implemented as a combination of the two, with certain functions facilitated by hardware alone, and other functions facilitated by a combination of hardware and software. In certain implementations, at least a portion, and in some cases all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices) that executes an operating system, system programs, and application programs, while also implementing the engine using multitasking, multithreading, distributed (e.g., cluster, peer-peer, cloud) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-module or sub-engine, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 900 may be a computer, a workstation, a laptop, a server such as a cloud-based server, or any other suitable device. In some embodiments, the computing device 900 is a server that includes one or more processing units, such as one or more graphical processing units (GPUs), one or more central processing units (CPUs), and/or one or more processing cores. The computing device 900 may, in some embodiments, execute one or more virtual machines. In some embodiments, processing resources (e.g., capabilities) of the computing device 900 are offered as a cloud-based service (e.g., cloud computing).

Although embodiments are illustrated herein including certain systems and/or devices, it will be appreciated that additional systems, servers, storage mechanisms, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Identification of intervention interface elements associated with user-specific attrition can be burdensome and time consuming, especially where attrition likelihood is not determined on a per-user basis. Systems including trained attrition prediction models, as disclosed herein, significantly reduce this problem, allowing systems to identify users that have an attrition likelihood above a predetermined threshold. Beneficially, programmatically identifying users having a high likelihood of attrition and presenting intervention interfaces may reduce or eliminate user attrition for one or more network systems.

It will be appreciated that user-specific attrition likelihood determinations as disclosed herein, particularly in network systems having large user bases, are only possible with the aid of computer-assisted machine-learning algorithms and techniques, such as the disclosed attrition prediction models. In some embodiments, machine-learning processes including attrition prediction models are used to perform operations that cannot practically be performed by a human, either mentally or with assistance, such as user-specific attrition likelihood determinations. It will be appreciated that a variety of machine-learning techniques can be used alone or in combination to generate a user-specific attrition likelihood prediction.

Although the subject matter has been described in terms of example embodiments, it is not limited thereto. Rather, the appended claims should be construed broadly to include other variants and embodiments that may be made by those skilled in the art.

What is claimed is:

1. A system, comprising:
a processor; and
a non-transitory memory storing instructions that, when executed, cause the processor to:
receive a plurality of time series datasets that each include a plurality of interaction data points, wherein each of the plurality of interaction data points includes a corresponding time stamp;
extract one or more features from each time series dataset in the plurality of time series datasets;
generate a time series label for each time series dataset in the plurality of time series datasets based at least in part on a gap between each of the plurality of interaction data points;
train an attrition prediction model using the plurality of time series datasets and the time series label for each time series dataset in the plurality of time series datasets, wherein the attrition prediction model generates an attrition likelihood;
receive a user-specific time series dataset;
generate a user-specific attrition likelihood for the user-specific time series dataset using the attrition prediction model;
generate an interface intervention based on the user-specific attrition likelihood; and
transmit instructions that cause an interface including the interface intervention to be displayed on a user device associated with the user-specific time series dataset.

2. The system of claim 1, wherein the one or more features comprise one or more network interface interactions, electronic communication interactions, application interactions, user features, or device features.

3. The system of claim 1, wherein the attrition prediction model comprises an XGBoost model including hyper-parameters fine-tuned using a Bayesian optimization.

4. The system of claim 1, wherein the plurality of time series datasets are selected from a candidate plurality of time series datasets using a multi-tiered filtration process.

5. The system of claim 4, wherein the multi-tiered filtration process includes at least one filter level based on an interval between interactions.

6. The system of claim 1, wherein the time series label identifies a gap between a most recent interaction and a second most recent, a mean of interaction gaps, and a standard deviation of the interaction gaps.

7. The system of claim 1, wherein the interface including the interface intervention comprises an electronic communication.

8. A computer-implemented method, comprising:
receiving a plurality of time series datasets that each includes a plurality of interaction data points, wherein each of the plurality of interaction data points includes a corresponding time stamp;
obtaining one or more features for each time series dataset in the plurality of time series datasets;
generating a time series label for at least a subset of time series datasets in the plurality of time series datasets based at least in part on a gap between each of the plurality of interaction data points;
training an attrition prediction model using the subset of time series datasets and the time series label for each time series dataset in the subset of time series datasets, wherein the attrition prediction model generates an attrition likelihood;
receiving a user-specific time series dataset;
generating a user-specific attrition likelihood for the user-specific time series dataset using the attrition prediction model;
generating an interface intervention based on the user-specific attrition likelihood; and
transmitting instructions that cause an interface including the interface intervention to be displayed on a user device associated with the user-specific time series dataset.

9. The computer-implemented method of claim 8, wherein the one or more features comprise one or more network interface interactions, electronic communication interactions, application interactions, user features, or device features.

10. The computer-implemented method of claim 8, wherein the attrition prediction model comprises an XGBoost model including hyper-parameters fine-tuned using a Bayesian optimization.

11. The computer-implemented method of claim 8, wherein the subset of time series datasets is selected from the plurality of time series datasets using a multi-tiered filtration process.

12. The computer-implemented method of claim 11, wherein the multi-tiered filtration process includes at least one filter level based on an interval between interactions.

13. The computer-implemented method of claim 8, wherein the time series label identifies a gap between a most recent interaction and a second most recent interaction, a mean of interaction gaps, and a standard deviation of the interaction gaps.

14. The computer-implemented method of claim 8, wherein the interface including the interface intervention comprises an electronic communication.

15. A non-transitory computer-readable medium storing instructions that, when executed by at least one processor, cause a device to perform operations comprising:
receiving a plurality of time series datasets that each include a plurality of interaction data points, wherein each of the plurality of interaction data points includes a corresponding time stamp;
extracting one or more features from each time series dataset in the plurality of time series datasets;
generating a time series label for each time series dataset in the plurality of time series datasets based at least in part on a gap between each of the plurality of interaction data points;
training an attrition prediction model using the plurality of time series datasets and the time series label for each time series dataset in the plurality of time series datasets, wherein the attrition prediction model generates an attrition likelihood;
receiving a user-specific time series dataset;
generating a user-specific attrition likelihood for the user-specific time series dataset using the attrition prediction model;
generating an interface intervention based on the user-specific attrition likelihood; and
transmitting instructions that cause generation of an interface including the interface intervention to a user device associated with the user-specific time series dataset.

16. The non-transitory computer-readable medium of claim 15, wherein the one or more features comprise one or more network interface interactions, electronic communication interactions, application interactions, user features, or device features.

17. The non-transitory computer-readable medium of claim 15, wherein the attrition prediction model comprises an XGBoost model including hyper-parameters fine-tuned using a Bayesian optimization.

18. The non-transitory computer-readable medium of claim 15, wherein the plurality of time series datasets are selected from a candidate plurality of time series datasets using a multi-tiered filtration process.

19. The non-transitory computer-readable medium of claim 18, wherein the multi-tiered filtration process includes at least one filter level based on an interval between interactions.

20. The non-transitory computer-readable medium of claim 15, wherein the time series label identifies a gap between a most recent interaction and a second most recent interaction, a mean of interaction gaps, and a standard deviation of the interaction gaps.
